(19) United States
(12) Patent Application Publication
(10) Pub. No.: US 2006/0008621 A1
(43) Pub. Date: Jan. 12, 2006

(54) Textured air laid substrate

(76) Inventors: Robert Irving Gusky, Appleton, WI (US); Juha P. Kemppinen, Evans, GA (US); Steven Gerald Sukowatey, Appleton, WI (US); Kevin Christopher Possell, Middleton, WI (US)

Correspondence Address: KIMBERLY-CLARK WORLDWIDE, INC., 401 NORTH LAKE STREET, NEENAH, WI, 54956, US

(21) Appl. No.: 10/887,732

(22) Filed: Jul. 8, 2004

(51) Int. Cl. B32B 21/10; B32B 3/00; B32B 5/14

(52) U.S. Cl. 428/156; 442/413; 442/415; 442/416; 428/171; 428/187; 264/119; 264/121; 264/128

(57) ABSTRACT

By replacing the fabric in the transfer section of an air laid machine with a transfer fabric having a specific compressibility as measured by P&J hardness, and then compacting the air laid web on the transfer fabric's surface when nipped between an engraved compaction roll and a backing roll, a highly textured air-laid web can be manufactured. In one embodiment, by using specific binders to form the air laid web a dispersible air laid web having a highly textured surface can be made. The textured air laid web can be moistened to form a wet wipe suitable for personal body cleaning.

### BACKGROUND

Wet wipes are used for a variety of purposes such as cleaning household surfaces and personal body cleansing. The substrate from which the wet wipe is manufactured can be selected from a wide variety of materials. Frequently, nonwoven substrates are used to produce wet wipes due to their desirable properties and low cost of manufacture. In general, the substrate's texture should be matched to the intended use of the substrate. For certain applications, a more textured substrate can enhance the cleaning ability of the wet wipe and give a more cloth-like feel to the substrate.

One useful substrate for a wet wipe is an air laid web. An air laid web can be produced by dry fiberizing appropriate fibers, directing the fibers onto a forming fabric, hydrating and compacting the air laid web, adding binders as necessary to improve the strength and integrity of the web, and then drying the web. While the air laid web process can produce a wide variety of useful substrates, it can be difficult to produce a more textured substrate as opposed to a wet formed paper web. Part of the difficulty is believed to result from the reduced ability to mold the web during formation, since the dry fibers are not as readily deformable when compared to the wet slurry of fibers in a wet laid process.

Therefore, what is needed is an air laid process for forming a substrate having the ability to produce more textured substrates. Also, what is needed is an air laid web having a textured surface comparable to or greater in texture than a typical wet laid paper web. Finally, what is needed is a resilient texture that remains in the substrate after wetting the substrate to form a wet wipe.

### SUMMARY

The inventors have discovered that by replacing the fabric in the transfer section of an air laid machine with a transfer fabric having a specific compressibility, and then compacting the air laid web on the transfer fabric's surface when nipped between an engraved compaction roll and a backing roll, a highly textured air-laid web can be manufactured. In one embodiment, the inventors have determined that by using specific binders to form the air laid web, a dispersible air laid web having a highly textured surface can be created. The air laid web can be moistened to form a wet wipe, and the web's texture will remain even when saturated with fluid. The moistened textured web provides an exceptional, low cost wet wipe for use in personal and household cleaning.

In one aspect, the invention resides in an air laid substrate comprising: cellulosic fibers formed into a web by at least one air laid former; the substrate having two opposing surfaces and wherein at least one of the opposing surfaces comprises a textured surface; and the at least one textured surface has a Percent Shadow Area greater than about 10 percent.

In another aspect, the invention resides in a method of producing an air laid substrate comprising the steps of: air forming cellulosic fibers into an air laid web; hydrating the air laid web; compacting the air laid web between an engraved compaction roll and a transfer fabric backed by a backing roll to form a textured air laid web, the transfer fabric having a P&J hardness greater than about 30; applying a binder to the textured air laid web; and drying the textured air laid web.

### BRIEF DESCRIPTION OF THE DRAWINGS

The above aspects and other features, aspects, and advantages of the present invention will become better understood with regard to the following description, appended claims, and accompanying drawings in which:

FIG. 1 is a schematic illustration of an air laying forming apparatus.

FIG. 2 is a schematic illustration of an air laying process to produce an air laid web.

FIG. 3 illustrates a photomicrograph of an air laid web produced by the invention.

FIG. 4 illustrates a photomicrograph of an air laid web produced by the invention.

FIG. 5 illustrates a photomicrograph of an air laid web produced by the invention.

FIG. 6 illustrates a photomicrograph of an air laid web produced by the invention.

FIG. 7 is a schematic illustration of a test method for measuring the Shadow Index of an air laid web.

Repeated use of reference characters in the specification and drawings is intended to represent the same or analogous features or elements of the invention.

### DEFINITIONS

As used herein, forms of the words “comprise”, “have”, and “include” are legally equivalent and open-ended. Therefore, additional non-recited elements, functions, steps or limitations may be present in addition to the recited elements, functions, steps, or limitations.

### DETAILED DESCRIPTION

It is to be understood by one of ordinary skill in the art that the present discussion is a description of exemplary embodiments only, and is not intended as limiting the broader aspects of the present invention, which broader aspects are embodied in the exemplary construction.

In general, the present invention is directed to an air laid web and the various processes for producing the air laid web. The air laid substrate of the present invention is produced by forming an air laid nonwoven web containing cellulosic fibers. The formed air laid web is then compacted while being embossed to a desired density and treated with a binder material. The binder material can be sprayed onto the air laid web. For most applications, for instance, the binder material is applied to both sides of the web. After application of the binder material, the air laid web can be cured and dried.

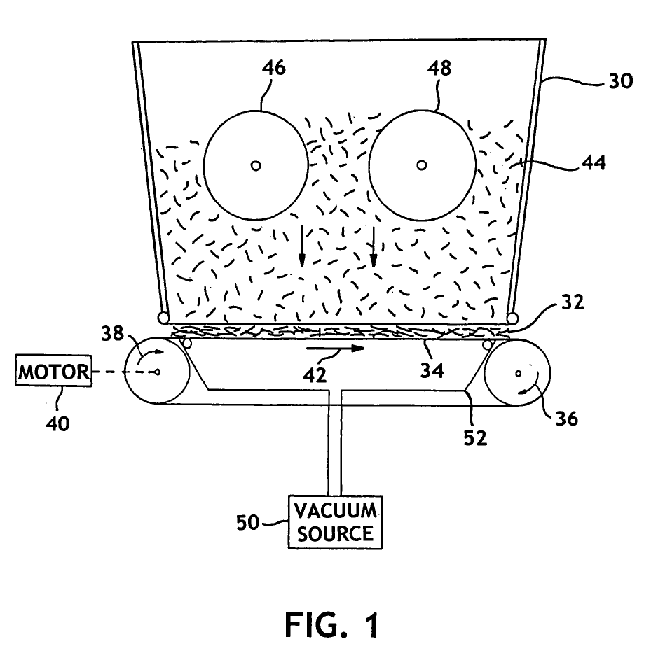

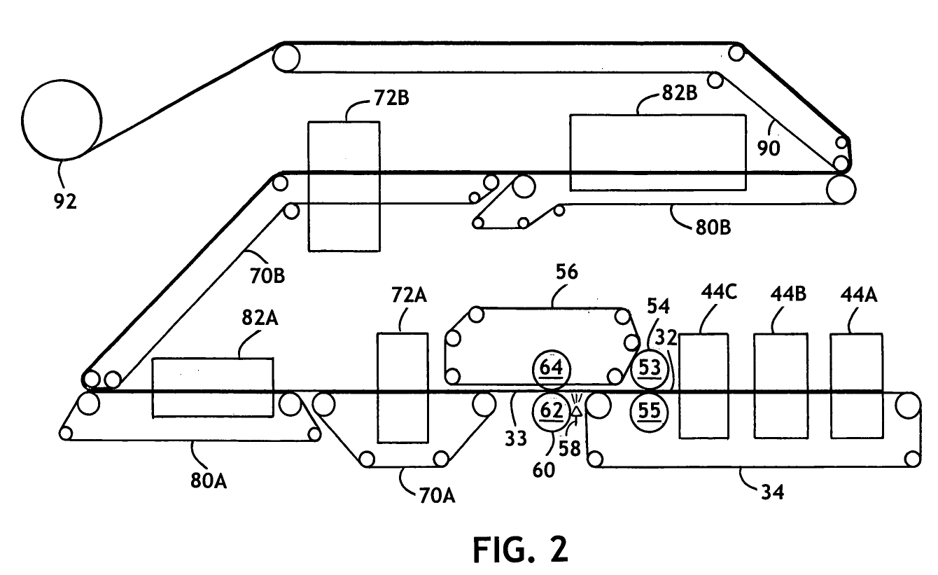

One embodiment of a process for forming air laid webs in accordance with the present invention will now be described in detail with particular reference to FIGS. 1 and 2. It should be understood that the air laying apparatus illustrated in FIGS. 1 and 2 is provided for exemplary purposes only and that any suitable air laying equipment may be used in the process of the present invention. Referring to FIG. 1, an air laying forming station 30 is shown which produces an air laid web 32 on a forming fabric or screen 34. The forming fabric 34 can be in the form of an endless belt mounted on support rollers 36 and 38. A suitable driving device, such as an electric motor 40 rotates at least one of the support rollers 38 in a direction indicated by the arrows at a selected speed. As a result, the forming fabric 34 moves in a machine direction indicated by the arrow 42.

The forming fabric 34 can be provided in other forms as desired. For example, the forming fabric can be in the form of a circular drum which can be rotated using a motor as disclosed in U.S. Pat. No. 4,666,647, U.S. Pat. No. 4,761,258, or U.S. Pat. No. 6,202,259, which are incorporated herein by reference. The forming fabric 34 can be made of various materials, such as plastic or metal.

Various suitable forming fabrics for use with the invention can be made from woven synthetic strands or yams. One suitable forming fabric is an ElectroTech 100S, available from Albany International having an office in Albany, N.Y. The ElectroTech 100S fabric is a 97 mesh by 84 count fabric with an approximate air permeability of 575 cfm, an approximate caliper of 0.048 inch, and a percent open area of approximately 0 percent.

As shown, the air laying forming station 30 includes a forming chamber 44 having end walls and side walls. Within the forming chamber 44 are a pair of material distributors 46 and 48 which distribute fibers and/or other particles inside the forming chamber 44 across the width of the chamber. The material distributors 46 and 48 can be, for instance, rotating cylindrical distributing screens.

In the embodiment shown in FIG. 1, a single forming chamber 44 is illustrated in association with the forming fabric 34. It is understood that more than one forming chamber can be included in the system. By including multiple forming chambers, layered webs can be formed in which each layer is made from the same or different materials.

Air laying forming stations, as shown in FIG. 1, are available commercially through Dan-Webforming Int. LTD. of Aarhus, Denmark. Other suitable air laying forming systems are also available from M & J Fibretech of Horsens, Denmark. As described above, any suitable air laying forming system can be used in accordance with the present invention.

As shown in FIG. 1, below the air laying forming station 30 is a vacuum source 50, such as a conventional blower, for creating a selected pressure differential through the forming chamber 44 to draw the fibrous material against the forming fabric 34. If desired, a blower can also be incorporated into the forming chamber 44 for assisting in blowing the fibers down onto the forming fabric 34.

In one embodiment, the vacuum source 50 is a blower connected to a vacuum box 52, which is located below the forming chamber 44 and the forming fabric 34. The vacuum source 50 creates an airflow indicated by the arrows positioned within the forming chamber 44. Various seals can be used to increase the positive air pressure between the chamber and the forming fabric surface.

During operation, typically a fiber stock is fed to one or more defibrators (not shown) and fed to the material distributors 46 and 48. The material distributors distribute the fibers evenly throughout the forming chamber 44 as shown. Positive airflow created by the vacuum source 50, and possibly an additional blower, forces the fibers onto the forming fabric 34, thereby forming an air laid non-woven web 32.

The material that is deposited onto the forming fabric 34 will depend upon the particular application. The fiber material that can be used to form the air laid web 32, for instance, can include natural fibers alone or in combination with synthetic fibers. Examples of natural fibers include wood pulp fibers, cotton fibers, wool fibers, silk fibers and the like, as well as combinations thereof. Synthetic fibers can include rayon fibers, polyolefin fibers, polyester fibers and the like, as well as combinations thereof. Polyolefin fibers include polypropylene fibers and polyethylene fibers. The synthetic fibers may be bi-component fibers, with a core of polypropylene and a polyethylene sheath.

The fibers can have various lengths, such as up to about 6 mm to about 8 mm or greater. The wood pulp fibers in the air laid web may be in a rolled and fluffed form. As is known to those skilled in the art, fluffed fibers generally refer to fibers that have been shredded.

It is known that air laid webs formed with high levels of synthetic fibers can be thermally bonded or heat embossed off-line to form textured webs. “Off-line” as used herein refers to processing steps and machinery performed after the air laid web is cured and wound into an initial roll or reel. The off-line machinery then unwinds the roll and performs additional processing steps as required. Synthetic fibers can be expensive and the textured air laid web of the present invention achieves suitable texture levels without incorporating high levels of synthetic fibers. Furthermore, the texture is achieved on-line prior to drying and curing the air laid web. However, low levels of the synthetic fibers can be utilized to produce a cost effective textured air laid web if desired. The synthetic fiber percentage of the textured air laid web of the present invention can be between about 0 percent to about 15 percent, or between about 0 percent to about 10 percent, or between about 0 percent to about 5 percent, or between about 0 percent to about 2 percent. In one embodiment, the textured air laid web contained no synthetic fibers and was composed entirely of cellulosic fibers.

Synthetic fibers can have other disadvantages besides cost. For example, if the air laid web is intended to be a dispersible web, the synthetic fibers can prevent the web from readily dispersing or disintegrating in water. Synthetic fibers also generally have an average fiber length that is approximately 6 mm-10 mm, while cellulosic fibers have a much shorter average fiber length of approximately 1 mm-3 mm. Inclusion of higher percentages of synthetic fibers can significantly reduce the throughput of the forming station 30, resulting in reduced output of the finished air laid web at a given basis weight when compared to the same basis weight web produced without any synthetic fibers.

If desired, low coarseness softwood fibers can be incorporated into the web. Low coarseness softwood fibers include, for instance, RAUMA CELL BIOBRIGHT TR pulp obtained from UPM-Kymmene, which is made from Scandinavian softwood fibers. The low coarseness softwood fibers can be defiberized by being processed through, for instance, a hammermill. Low coarseness softwood fibers typically have a relatively small diameter and are smaller in length than comparable fibers. The low coarseness softwood fibers can have a Pulp Coarseness Index of less than about 18 mg/100 m, such as less than about 16.5 mg/100 m. For instance, in one embodiment, the fibers may have a Pulp Coarseness Index of less than about 15 mg/100 m. The low coarseness softwood fibers may be used alone or in combination with various other fibers in forming the air laid web. Further, different types of low coarseness softwood fibers may be combined to form the web as well.

The pulp fibers used to form air laid webs in accordance with the present invention may be pretreated with a debonder agent prior to incorporation into the air laid web. Suitable debonder agents that may be used in the present invention include cationic debonder agents, such as fatty dialkyl quaternary amine salts, mono fatty alkyl tertiary amine salts, primary amine salts, imidazoline quaternary salts, silicone quaternary salt and unsaturated fatty alkyl amine salts. Other suitable debonder agents are disclosed in U.S. Pat. No. 5,529,665 to Kaun, which is incorporated herein by reference. In particular, Kaun discloses the use of cationic silicone compositions as debonder agents. A suitable commercially available debonder agent is an organic quaternary ammonium chloride and particularly a silicone based amine salt of a quaternary ammonium chloride such as PROSOFT TQ1003 marketed by the Hercules Corporation. The debonder agent can be added to the fibers in an amount of between about 1 kg per metric tonne to about 6 kg per metric tonne of fibers present.

When forming the air laid web 32 from different materials and fibers, the forming chamber 44 can include multiple inlets for feeding the materials to the chamber. Once in the chamber, the materials can be mixed together if desired. Alternatively, the different materials can be separated into different layers when forming the web.

Referring to FIG. 2, a schematic diagram of an entire web forming system useful for making air laid substrates is shown. In this embodiment, the system includes three separate air laying forming chambers 44A and 44B and 44C. As described above, the use of multiple forming chambers can serve to facilitate formation of the air laid web at a desired basis weight. Further, using multiple forming chambers can allow for the formation of layered webs. As shown, forming stations 44A, 44B and 44C contribute to the formation of the air laid web 32.

Air laid web 32, after exiting the forming chambers 44A, 44B and 44C, is conveyed on the forming fabric 34 to a compaction device 54. The compaction device 54 can be a pair of opposing rolls that define a nip through which the air laid web and forming fabric is passed. In one embodiment, the compaction device can comprise a steel roll 53 positioned above a covered roll 55, having a resilient roll covering for its outer surface. The compaction device increases the density of the air laid web to generate sufficient strength for transfer of the air laid web to a transfer fabric 56 such as, for instance, via an open gap arrangement. In general, the compaction device increases the density of the web over the entire surface area of the web as opposed to only creating localized high density areas.

The compaction rolls (53, 55) can be between about 10 inches to about 30 inches in diameter and can be optionally heated to further enhance their operation. For example, the steel roll can be heated to a temperature between about 150° F. to about 500° F. The compaction rolls can be operated at either a specified loading force or can be operated at specified gap between the surfaces of each roll. Too much compaction will cause the web to lose bulk in the finished product, while too little compaction can cause runnability problems when transferring the air laid web to the next section in the process.

Alternatively, the compaction device 54 can be eliminated and the transfer fabric 56 and the forming fabric 34 can be brought together such that the air laid web 32 is transferred from the forming fabric to the transfer fabric. The transfer efficiency can be enhanced by use of suitable vacuum transfer boxes and/or pressured blow boxes as known in the art.

After the air laid web 32 is transferred to the transfer fabric, it is hydrated by a spray boom 58 with liquid such as water. The percent moisture of the air laid web after hydration, based as a weight percent of the dry fibers of the web, can be between about 0.1 percent to about 5 percent, or between about 0.5 percent to about 4 percent, or between about 0.5 percent to about 2 percent. Too much moisture can cause the air laid web to adhere to the transfer fabric and not release for transfer to the next section of the process, while too little moisture can reduce the amount of texture generated in the web.

After hydration, the moistened air laid web, while residing on the transfer fabric 56, is embossed by an embossing device 60. The embossing device can be an optionally heated engraved compaction roll 62 that is nipped with a backing roll 64 through which the air laid web 32 residing on the transfer fabric 56 is sent to form a textured air laid web 33.

The inventors have discovered that a specific combination of process parameters are needed to form a textured air laid web, which has superior texture as measured by the Percent Shadow Area test herein later described. In particular, the compressibility of the transfer fabric along with the height and/or pattern of the engraved compaction roll 62, the degree of hydration, the temperature of the engraved compaction roll, and the nip load can be controlled to produce the desired textured air laid web 33. In developing the present invention, it is believed that no single factor contributed to the results obtained. Instead, it is believed that multiple factors taken in combination produced the inventive results.

With regard to the transfer fabric 56, and specifically its interaction with the engraved compaction roll 62, the inventors have discovered that by selecting fabrics having a specific compressibility a wet resilient textured air laid web having superior texture is produced. The compressibility of the transfer fabric is determined by measuring the depth of an indention made in the surface of the transfer fabric by a steel ball (3.175 mm diameter) under a constant load (1000 grams) for a specified time period (60 seconds). The measured indention is the Pusey and Jones number often abbreviated as the P&J hardness. Similar testing is frequently carried out on rubber covered rolls using a Plastometer Model 1000, or equivalent, to determine the rubber covered roll's P&J hardness. The instrument and method of testing is described in ASTM D 531 Standard Test Method for Rubber Property—Pusey and Jones Indentation and in Metso Paper No. 25 Measuring the Hardness of Rubber Covered Rolls (Plastometer test).

Use of the Plastometer to test the compressibility of a fabric is believed to a novel and heretofore undisclosed method for selecting a transfer fabric having specific properties in order to produce a textured air laid web. While P&J hardness has been used on rubber covered rolls, this method of hardness testing on a paper machine fabric can be used to select fabrics having desirable properties to generate more texture in the web. In particular, the transfer fabric should have P&J hardness of between about 30 to about 150, or between about 50 to about 150, or between about 100 to about 150. Thus, transfer fabrics having too low of a hardness number will generate insufficient texture or no texture, while transfer fabrics having too great of a hardness number can have a very short running life.

With regard to compressibility and life of the transfer fabric, the inventors believe that the denier of the yams forming the transfer fabric should also be controlled. Transfer fabrics having yams with too fine of denier will have less than desired life, and those having yams too large in denier will not have a sufficiently smooth surface for good transfer of the air laid web. In various embodiments of the invention, the denier of the yarns forming the transfer fabric can be 10 or greater, or between about 10 to about 40, or between about 10 to about 25.

Suitable transfer fabrics for use with the invention can include paper machine felts having the specified P&J hardness range. For example, a Millennium Axxial felt is suitable for use with the present invention. Millennium Axxial felts are available from Weavexx, a subsidiary of Xerium Technologies, Inc., having an office in Westborough Mass.

The pattern placed onto the engraved compaction roll can be any suitable pattern or icon that develops the desired texture. In particular, the pattern's Percent Bond Area is believed to be one factor that can be used to select an appropriate pattern. The Percent Bond Area is defined as the area of the raised embossing pattern on the embossing roll expressed as a percentage of the total area of the roll's surface that will be in contact with the web. This can be measured directly from the embossing roll by a number of methods or measured indirectly by measuring the embossed substrate produced by the embossed roll. The area used to calculate the Percent Bond Area should be sufficiently large to encompass at least one entire repeat of the embossing pattern. Embossing patterns suitable for use with the present invention can have a Percent Bond Area between about 4 percent to about 50 percent, or between about 4 percent to about 25 percent, or between about 4 percent to about 15 percent or between about 6 percent to about 12 percent. The Percent Bond Area should be sufficiently large to generate adequate texture and strength in the web while not being too large, causing increased stiffness or bulk loss in the air laid web.

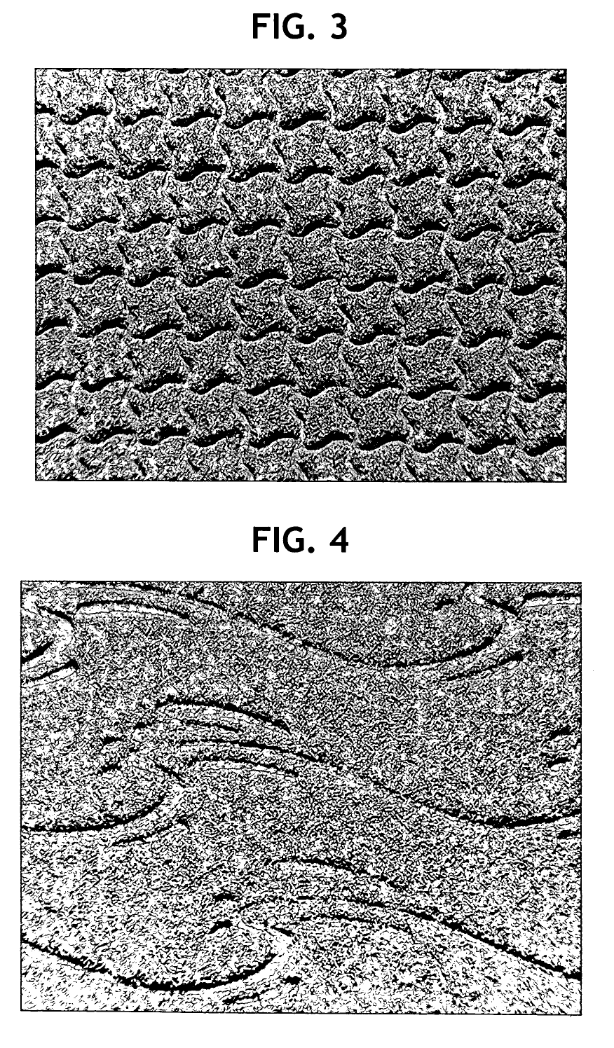

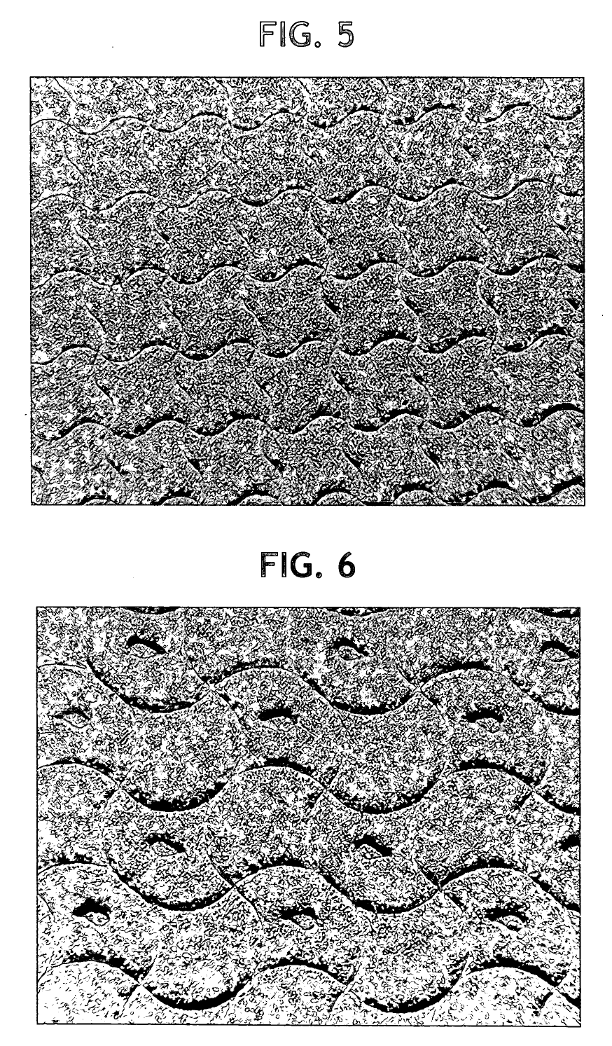

Referring now to FIGS. 3-6, several textured air laid webs produced by the invention are shown. These Figures were taken by the camera during measurement of the Percent Shadow Area test and are approximately 1.8 times larger the actual size. In FIG. 3, the longer diagonal of an individual embossed enclosed cell when measured from corner to corner on the embossing plate was approximately 10 mm and the shorter diagonal was approximately 9 mm. In FIG. 5, the longer diagonal of an individual embossed enclosed cell when measured from corner to corner on the embossing plate was approximately 14 mm and the shorter diagonal was approximately 13 mm. In FIG. 6, the distance across the bottom of the large curve (across the bottom of the umbrella from canopy edge to canopy edge) when measured on the embossing plate was approximately 19 mm.

The type of pattern placed onto the air laid web can have an influence on the texture produced. In one embodiment, as seen in FIGS. 3, 5, and 6, the pattern can comprise a network pattern wherein the embossed lines forming the pattern are interconnected in both the machine and cross machine directions. A “network pattern” as used herein means that the embossing pattern has a series of interconnected lines that enclose a plurality of unembossed regions such that the lines form a mesh. Without wishing to be bound by theory; it is believed that when a network pattern is used it forms a continuous and interconnected densified network within the sheet. When the binder material is then applied to the sheet and cured, the binder causes a higher number of bonds to occur in these higher density areas and form a continuous network of locally higher strength. This interconnected network of strength can result in more efficient use of the binder by generating a higher tensile strength substrate with less binder. In addition, this allows the creation of an air laid web that is thick, strong, and resistant to splitting or delamination of the sheet into two separate halves without the use of extra binder. When a thick air laid web is made, it can be weaker due to the lower number of fiber cross points and prone to split in half because most of the binder remains on the surface. In other embodiments, the pattern can be a discrete pattern having individual spot designs or icons separated by blank or unembossed areas or a line pattern that is not interconnected to from a network pattern.

The engraved compaction roll 62 can have an engraving depth between about 0.020 inch to about 0.100 inch, or between about 0.025 inch to about 0.060 inch, or between about 0.030 inch to about 0.050 inch as measured from the top of the engraving elements to their base. If the embossing pattern is too shallow, less texture will be generated in the air laid web since the interaction of the embossing pattern with the transfer fabric will be insufficient, especially as the P&J hardness of the transfer fabric decreases.

To enhance the texture generated by the engraved compaction roll 62, the engraved compaction roll can be heated. The compaction roll 62 can be heated to a temperature ranging between 150° F. to about 500° F., or between about 200° F. to about 500° F., or between about 250° F. to about 500° F.

The backing roll 64 can be a steel roll or a rubber covered roll having either a natural or synthetic compressible cover. The engraved compaction roll and the backing roll can have a diameter between about 10 inches to about 30 inches. The engraved compaction roll and the backing roll can be loaded together with a nip load expressed in pounds force per lineal inch (pli) of between about 50 pli to about 400 pli, such as between about 200 pli to about 300 pli. The nip load chosen is to some extent dependent on the line speed of the machine, since the load force as a function of time (dwell time) in the nip represents the energy available for deforming the air laid web.

Next, the textured air laid web 33 is transferred to a spray fabric 70A and fed to a spray chamber 72A. Within the spray chamber 72A, a binder is applied to one side of the textured air laid web 33. The binder material can be deposited on the top side of the web using, for instance, spray nozzles. Under fabric vacuum may also be used to regulate and control penetration of the binder material into the web.

The binder applied to the textured air laid web should be selected such that the binder will retain the web's texture when moistened to form a textured wet wipe. Furthermore, the binder material should retain the web's texture even after the wet wipe has been dried so as to be substantially free of moisture. As used herein, “substantially free of moisture” means that the wet wipe has been dried to a moisture content of less than about 15 percent such that the wet wipe feels dry to the touch. Textured webs of the present invention are distinguished from other webs that may have been embossed in an off-line operation, or from wet formed webs that may have been formed or molded by a molding fabric and then dried. The texture in the textured air laid web is locked in by the binder material and the subsequent drying process. The binder material can also add to the dry strength, wet strength, stretchability, and tear resistance of the textured air laid web.

Particular binder materials that may be used in the present invention include latex compositions, such as acrylates, vinyl acetates, vinyl chlorides and methacrylates. Some water-soluble binder materials may also be used, including polyacrylamides, polyvinyl alcohols and cellulose derivatives such as carboxymethyl cellulose. In one embodiment, the binder materials used in the process of the present invention comprise an ethylene vinyl acetate copolymer. In particular, the ethylene vinyl acetate copolymer can be cross-linked with N-methyl acrylamide groups using an acid catalyst. Suitable acid catalysts include ammonium chloride, citric acid and maleic acid.

In one embodiment of the invention, a dispersible binder material is used such that after drying the textured air laid web is dispersible. Suitable dispersible binder materials can include those disclosed in U.S. patent application Ser. No. 09/564,531 entitled Ion-Sensitive Water Dispersible Polymers, A Method of Making Same And Items Using, filed on May 4, 2000; U.S. patent application Ser. No. 09/900698 entitled Pre-Moistened Wipe Product, filed on Jul. 7, 200; and in U.S. patent application Ser. No. 10/251,610 entitled Improved Ion Triggerable, Cationic Polymers, A Method of Making Same and Items Using Same, filed on Aug. 20, 2002; the disclosures of each herein incorporated by reference. Other dispersible chemistries are disclosed in the following U.S. Pat. Nos.: 6,683,129; 5,264,269; 5,281,306; 5,312,883; 5,631,317; 5,384,189; and 5,317,063. One suitable dispersible binder uses NaAMPS SSB as a dispersible binder. Another suitable dispersible binder uses low charge density, cationic polyacrylates for the dispersible binder.

Dispersible binder materials can require the addition of more binder material to generate sufficient tensile strengths in the substrate. The additional binder material applied to the web can increase the wetness or moisture content of the textured air laid web prior to drying. Thus, the spray chamber 72A can “wash out” any pattern placed onto the textured web when making a dispersible substrate since the texture has yet to be locked in by curing and drying of the binder material. The additional moisture from the additional binder material can cause the textured pattern within the substrate to relax or fade. The present invention generates sufficient texture such that even dispersible air laid webs can be made that resist relaxation of the pattern prior to curing and drying. Additionally, dispersible webs of the present invention generate superior texture as compared to textured dispersible webs produced from an off-line embossing process after curing and drying of the binder material. The pattern placed into a dispersible air laid web in an off-line embossing process frequently is pulled out or diminished by additional downstream converting operations. Since the texture generated by the present invention is locked in by the curing step, the texture is less affected by additional converting steps.

Particular examples of binder materials that may be used in the present invention include AIRFLEX EN1165, available from Air Products, Inc., or ELITE PE BINDER, available from National Starch. It is believed that both of the above binder materials are ethylene vinyl acetate copolymers. A commercially available dispersible binder material is VINAC 911 available from Air Products, Inc.

The binder material can be applied so as to uniformly cover the entire surface area of at least one side of the web. For instance, the binder material can be applied to the first side of the web so as to cover at least about 80 percent of the surface area of one side of the web, such as at least about 90 percent of the surface area of one side of the web. In other embodiments, the binder material can cover greater than about 95 percent of the surface area of one side of the web.

The binder material should be applied to the air laid web in an amount sufficient to retain the texture generated by the engraved compaction roll after curing. In particular, the amount of the binder material can be about 10 percent to about 25 percent of the total weight of the substrate. The amount of binder required is determined by the desired wet tensile strength and caliper of the basesheet among other factors.

Once the binder material is applied to one side of the web, as shown in FIG. 2, the textured air laid web 33 is transferred to drying fabric 80A and fed to a drying apparatus 82A. In the drying apparatus 82A, the web is subjected to heat causing the binder material to dry and/or cure. When using an ethylene vinyl acetate copolymer binder material, the drying apparatus can be heated to a temperature of between about 120° C. to about 170° C.

From the drying apparatus 82A, the air laid web is then transferred to a second spray fabric 70B and fed to a second spray chamber 72B. In the spray chamber 72B, a second binder material is applied to the other untreated side of the air laid web. The first binder material and the second binder material can be different binder materials or the same binder material. The second binder material may be applied to the air laid web as described above with respect to the first binder material.

From the second spray chamber 72B, the textured air laid web is then transferred to a second drying fabric 80B and passed through a second drying apparatus 82B for drying and/or curing the second binder material. From the second drying apparatus 82B, the textured air laid web 33 is transferred to a return fabric 90 and then wound into a roll or reel 92. After winding, subsequent converting steps known to those of skill in the art can be used to transform the textured air laid substrate into a plurality of wet wipes. For example, the textured air laid substrate can be cut into individual wipes, the individual the wipes folded into a stack, the stack of wet wipes moistened with a cleaning solution, and then the stack of wet wipes can be placed into a dispenser.

The basis weight of the air laid products made according to the present invention can vary depending on the particular application and the desired use. For most embodiments, for instance, the basis weight of the air laid webs can be from about 35 gsm to about 120 gsm, such as from about 50 gsm to about 80 gsm.

The strength of the air laid products of the present invention can vary depending on the particular application and desired use. For most embodiments, the MDWT tensile strength can be between about 1,000 g/3″ to about 2,000 g/3″ such as between about 1,250 g/3″ to about 1,750 g/3″.

The texture of the air laid webs of the present invention can be measured using the Percent Shadow Area test. The inventive process described above can be used to produce air laid webs having superior texture as measured by the Percent Shadow Area test. The textured air laid webs can have a Percent Shadow Area greater than about 10 percent, or between about 10 percent to about 40 percent, or between about 10 percent to about 30 percent or between about 15 percent to about 30 percent. The textured air laid webs can have a Normalized Percent Shadow Area greater than about 10 percent, or between about 10 percent to about 50 percent, or between about 10 percent to about 40 percent or between about 15 percent to about 40 percent.

Of particular advantage, air laid webs made according to the present invention can have the above characteristics and properties without having to greatly increase the amount of pulp fibers that are used to make the webs. The air laid webs of the present invention can be used to make a wet wipe by wetting them with an appropriate solution depending on the specific use of the wet wipe. For example, wipes used to clean babies may have lower levels and different types of surfactants and active chemicals than wipes used to clean household surfaces. Wipes used to polish or clean cars may have different active ingredients from wipes intended for personal cleaning. The cleaning solution may contain, but is not limited to, surfactants, humectants, conditioners, fragrances, and antibacterial agents. The solution add-on as a percent of the dry weight of the basesheet can be between about 150 percent to about 350 percent. One suitable cleaning solution is disclosed in U.S. Pat. No. 6,673,358 issued to Cole et al. on Jan. 6, 2004 and herein incorporated by reference. When used as a wet wipe, the air laid webs can have a wet bulk between about 10 cc/g to about 15 cc/g.

### EXAMPLES

### Control 1

Control 1 was produced on a commercial airlaid machine using a process similar to FIG. 2. Southern Softwood Kraft Fluff pulp (Weyerhaeuser CF 405) was defiberized using DanWeb Type H 60 M hammermills operating at 3000 rpm. The fibers were transported to forming heads (Dan Web manufacture) operating at a needle roll speed of 4920 fpm and forming drum speed of 920 fpm. The fibers were then deposited onto a forming fabric (Albany ElectroTech 100S) and formed into a web. The embryonic web was then densified and strengthened by passing through the first set of compaction rolls. The top compaction roll was a smooth steel induction-heated roll (Tokuden, Inc.) which directly contacts the web and was operating at 275 Deg F.

The web was then transferred with vacuum to a Voith t1203-8 fabric installed in the transfer section having a P&J hardness of 12. The web was then humidified with water at an add-on of approx. 1.5 percent by weight based on the web's basis weight. Immediately thereafter, the web was further densified and strengthened by passing through the second set of compaction rolls. The bottom compaction roll was a smooth steel induction-heated roll (Tokuden, Inc.) which directly contacts the web and was operating at 350 Deg F. at a nip load of 250 pli.

The web was then transferred to the spray chamber 72A section. ELITE PE BINDER, an ethylene vinyl acetate copolymer available from National Starch was then applied to the web via spray boom at 18 percent solids and an add-on of 8.45 percent by total sheet weight. The web was then transferred to a multi-zone dryer operating at 400 degrees F. to evaporate water and cure the binder. The web was then transferred to the spray chamber 72B section. ELITE PE BINDER, an ethylene vinyl acetate copolymer available from National Starch was then applied to the opposite side of the web via spray boom at 18 percent solids and an add-on of 8.45 percent by total sheet weight. The web was then transferred to a multi-zone dryer operating at 400 Deg F. to evaporate water and cure the binder.

After the second dryer pass, the web was transferred to the reel section and wound into roll form. The basis weight of the air laid web was measured at 64.7 gsm. The air laid web was used to make a wet wipe by adding approximately 250 percent by weight (2.5 times the weight of the substrate) of a cleaning solution containing approximately 97 percent water and 3 percent active ingredients comprising Propylene Glycol, DMDM Hydantoin, Disodium Cocoamphodiacetate, Polysorbate 20, Fragrance, Iodopropynyl Butylcarbamate, Aloe Barbadensis, and Tocopheryl Acetate. The Percent Bond Area was measured by optical analysis from the markings left on nip impression paper passed between the compaction rolls and the transfer fabric. The resulting textured air laid web had a Percent Shadow Area of 0.6 percent, a Percent Bond Area of 7.7 percent, and a Normalized Percent Shadow Area of 0.8 percent.

### Control 2

Control 2 was produced on pilot equipment in a series of stages. Southern Softwood Kraft Fluff pulp (Weyerhaeuser CF 405) was defiberized using a pilot hammermill. The fibers were transported and deposited directly onto a 17 gsm tissue carrier sheet. A second 17 gsm tissue carrier sheet was then introduced on top of the embryonic web. The web (with both top and bottom carrier sheets) then passed through a pair of compaction rolls for densification and strengthening before being made into roll form at the reel section. The web at the reel section had an as-is basis weight of approximately 58 gsm.

The web was later cut to an approximately 6 inch×8 inch size and separated from both tissue carrier sheets. The unbonded web was then placed onto an Albany Electrotech 36B fabric of similar size having a P&J hardness of 10. A Beloit Wheeler Model 700 Calender was used for compaction. A magnesium plate was engraved with Pattern No. 935 (9.6 Percent Bond Area from the engraving drawing with a design as seen in FIG. 3) to a depth of 0.050 inch. The plate was then rolled and installed over the smooth steel heated roll of the Beloit Wheeler Model 700 calender. The calender was then preheated to a temperature of 105 degrees C. The Albany Electrotech 36B fabric with web was then fed through the calender at a speed of 20 fpm and gap setting to produce 10 pli. Based on prior testing, this was found to produce most similar results to basesheets produced under commercial conditions such as Control 1.

ELITE PE BINDER, an ethylene vinyl acetate copolymer available from National Starch, was then applied to the web via spray boom at 18 percent solids and an add-on of 5 gsm neat. The web was then dried in a Type LTV through-air dryer manufactured by Werner Mathis AG at process settings of: Fan Speed. 10 (Maximum), Drying Temperature 195 degrees C., and Drying Time of 15 seconds. ELITE PE BINDER, an ethylene vinyl acetate copolymer available from National Starch, was then applied to the opposite side of the web via spray boom at 18 percent solids and an add-on of 5 gsm neat. The web was then dried in a Type LTV through-air dryer manufactured by Werner Mathis AG at process settings of: Fan Speed 10 (Maximum), Drying Temperature 195 degrees C., and Drying Time of 15 seconds. The air laid web was used to make a wet wipe by adding approximately 250 percent by weight (2.5 times the weight of the substrate) of a cleaning solution containing approximately 97 percent water and 3 percent active ingredients comprising Propylene Glycol, DMDM Hydantoin, Disodium Cocoamphodiacetate, Polysorbate 20, Fragrance, Iodopropynyl Butylcarbamate, Aloe Barbadensis, and Tocopheryl Acetate.

The resulting textured air laid web had a Percent Shadow Area of 6.5 percent, a Percent Bond Area of 9.6 percent, and a Normalized Percent Shadow Area of 6.7 percent.

### Example 1

Example 1 was produced on pilot equipment using the same method as Control 2 except the Albany Electrotech 36B fabric was replaced with a Transmaster Open (TMO) felt manufactured by Tamfelt Corp. of Tampere, Finland. The felt had a P&J hardness of 37. The resulting textured air laid web had a Percent Shadow Area of 15.6 percent, a Percent Bond Area of 9.6 percent, and a Normalized Percent Shadow Area of 16.2 percent.

### Example 2

Example 2 was produced on pilot equipment using the same method as Control 2 except the Albany Electrotech 36B fabric was replaced with a Millennium felt manufactured by Weavexx, a Xerium Company, Westborough, Mass. The felt had a P&J hardness of 57. The resulting textured air laid web had a Percent Shadow Area of 26.5 percent, a Percent Bond Area of 9.6 percent, and a Normalized Percent Shadow Area of 27.5 percent.

### Example 3

Example 3 was produced on pilot equipment using the same method as Control 2 except the Albany Electrotech 36B fabric was replaced with an Axxial felt manufactured by Weavexx, a Xerium Company, Westborough, Mass. The felt had a P&J hardness of 107. The resulting textured air laid web is illustrated in FIG. 3, and it had a Percent Shadow Area of 26.2 percent, a Percent Bond Area of 9.6 percent, and a Normalized Percent Shadow Area of 27.2 percent.

### Example 4

Example 4 was produced on pilot equipment using the same method as Example 3 except the engraved depth of Pattern 935 was reduced from 0.050 inch to 0.030 inch. The resulting textured air laid web had a Percent Shadow Area of 22.5 percent, a Percent Bond Area of 9.6 percent, and a Normalized Percent Shadow Area of 23.4 percent.

### Example 5

Example 5 was produced on pilot equipment using the same method as Example 3 except the engraved depth of Pattern 935 was reduced from 0.050 inch to 0.010 inch. The resulting textured air laid web has a Percent Shadow Area of 4.5 percent, a Percent Bond Area of 9.6 percent, and a Normalized Percent Shadow Area of 4.7 percent.

### Example 6

Example 6 was produced on pilot equipment using the same method as Example 3 except the pattern was changed from Pattern 935 to Pattern SNG. Pattern SNG was calculated to have an 11.5 Percent Bond Area from the engraving drawing with a design as seen in FIG. 4. The resulting textured air laid web is illustrated in FIG. 4, and it had a Percent Shadow Area of 19.9 percent, a Percent Bond Area of 11.5 percent, and a Normalized Percent Shadow Area of 17.3 percent.

### Example 7

Example 7 was produced on pilot equipment using the same method as Example 3 except the pattern was changed from Pattern 935 to Pattern 217. Pattern 217 was calculated to have a 7.2 Percent Bond Area from the engraving drawing with a design as seen in FIG. 5. The resulting textured air laid web is illustrated in FIG. 5, and it had a Percent Shadow Area of 11.9 percent, a Percent Bond Area of 7.2 percent, and a Normalized Percent Shadow Area of 16.6 percent.

### Example 8

Example 8 was produced on pilot equipment using the same method as Example 3 except the pattern was changed from Pattern 935 to Pattern 568. Pattern 568 was calculated to have a 5.7 Percent Bond Area from the engraving drawing with a design as seen in FIG. 6. The resulting textured air laid web is illustrated in FIG. 6, and it had a Percent Shadow Area of 23.8 percent, a Percent Bond Area of 5.7 percent, and a Normalized Percent Shadow Area of 41.8 percent.

### Example 9

Example 9 was produced on a commercial airlaid machine using the same conditions as Control 1 with the following exceptions:
1. The Voith t1203-8 fabric was replaced with an Axxial felt manufactured by Weavexx, a Xerium Company, Westborough, Mass. The felt had a hardness of 107 P&J.
2. The smooth steel induction-heated roll (Tokuden, Inc.) was replaced with an engraved induction-heated roll (Tokuden, Inc.). This roll was engraved to a depth of 0.050 inch with Pattern 935.
3. The basis weight of finished product was measured at 68.8 gsm. The total percent binder in the textured air laid web was reduced from 16.9 percent for Control 1 to 14.7 percent for Example 9.

The resulting textured air laid web had a Percent Shadow Area of 18.6 percent, a Percent Bond Area of 9.6 percent, and a Normalized Percent Shadow Area of 19.4 percent.

### Example 10

Example 10 was produced on a commercial airlaid machine using the same conditions as Example 9 with the following except the ELITE PE BINDER, an ethylene vinyl acetate copolymer available from National Starch was replaced with a low charge density, cationic polyacrylate dispersible binder to make a dispersible textured air laid web. Such binders are disclosed in U.S. patent application Ser. No. 10/251,610 entitled Improved Ion Triggerable, Cationic Polymers, A Method of Making Same and Items Using Same, filed on Aug. 20, 2002. Additionally, salt (approximately 2 percent) was added to the wet wipes solution to prevent the web from dispersing until placed into excess water. The resulting dispersible textured air laid web had a Percent Shadow Area of 10.5 percent, a Percent Bond Area of 9.6 percent, and a Normalized Percent Shadow Area of 10.9 percent.

### Comparative 1

Comparative sample 1 is a PAMPERS' TIDY TYKES wet wipe sold by the Procter and Gamble Corporation. The product had a stamped code of 201032570101 TT and was purchased in the Fox Valley area of Wisconsin in February of 2004. The wet wipe had a Percent Shadow Area of 6.8 percent, a Percent Bond Area of 13.9 percent (measured by optical analysis), and a Normalized Percent Shadow Area of 4.9 percent.

### Comparative 2

Comparative sample 2 is a PARENTS CHOICE BABY WIPE manufactured by Nice-Pak Products, Inc. of Orangeburg, N.Y. The product had a stamped code of BN/0400011414 17:22 and was purchased in Appleton, Wis. in May of 2004. The wet wipe had a Percent Shadow Area of 2.5 percent, a Percent Bond Area of 9.7 percent (measured by optical analysis), and a Normalized Percent Shadow Area of 2.6 percent. The embossing for this product was fairly distinct and when tested, the product was found to have 38.7 percent synthetic fibers.

### Comparative 3

Comparative sample 3 is a PURE'nGENTLE wipe sold by Rockline Industries of Sheboygan, Wis. The product had a stamped code of D124 and was purchased in Appleton, Wis. in May of 2004. The product was tested and had a percent shadow area of 0.3 percent. The Percent Bond Area could not be determined by optical analysis.

### Comparative 4

Comparative sample 4 is a dry, uncreped through-air dried wet formed bath tissue. Such a product is sold by Kimberly-Clark Corporation as KLEENEX COTTONELLE bath tissue. The product was purchased in the Fox Valley area of Wisconsin in March 2004. The product was tested and had a percent shadow area of 27.8 percent. The Percent Bond Area could not be determined by optical analysis since the product was not embossed, but had a texture produced by wet molding to the paper machine fabric (t1203-8) prior to drying the web.

### Results

Table 1 and Table 2 summarize the results of the testing and specific process variables for the Examples. Comparing Control 1 to Comparative 4, even though the same transfer or molding fabric was used in a similar position in both the air laid process and the wet laid process, there was very little texture generated in the air laid web as measured by the Percent Shadow Area. Compare 27.8 percent for the wet laid paper web as opposed to only 0.6 percent for the air laid web. Comparing Control 2, Example 1, Example 2, and Example 3 it can be seen that the hardness of the transfer fabric has an influence on the generated texture as measured by the Percent Shadow Area test. (These results can be directly compared since Pattern 935 was used to emboss all the samples.) The measured Percent Shadow Area is significantly increased when the transfer fabric has a P&J hardness of about 35 or greater and significantly increased again when the hardness is about 50 or greater.

TABLE 1

| | | | | | Normalized |
|---|---|---|---|---|---|
| | | | Percent | Percent | Percent |
| | | | Shadow | Bond | Shadow |
| Sample Id. | Process | Transfer Fabric | Area | Area | Area |
| Control 1 | Commercial | Voith t1203-8 | 0.6 | 7.7 | 0.8 |
| Control 2 | Pilot | Albany Electrotech 36B | 6.5 | 9.6 | 6.7 |
| Example 1 | Pilot | Tamfelt TMO | 15.6 | 9.6 | 16.2 |
| Example 2 | Pilot | Weavexx Millennium | 26.5 | 9.6 | 27.5 |
| Example 3 | Pilot | Weavexx Axxial | 26.2 | 9.6 | 27.2 |
| Example 4 | Pilot | Weavexx Axxial | 22.5 | 9.6 | 23.4 |
| Example 5 | Pilot | Weavexx Axxial | 4.5 | 9.6 | 4.7 |
| Example 6 | Pilot | Weavexx Axxial | 19.9 | 11.5 | 17.3 |
| Example 7 | Pilot | Weavexx Axxial | 11.9 | 7.2 | 16.6 |
| Example 8 | Pilot | Weavexx Axxial | 23.8 | 5.7 | 41.8 |
| Example 9 | Commercial | Weavexx Axxial | 18.6 | 9.6 | 19.4 |
| Example 10 | Commercial | Weavexx Axxial | 10.5 | 9.6 | 10.9 |
| Comparative 1 | Commercial | — | 6.8 | 13.9 | 4.9 |
| Comparative 2 | Commercial | — | 2.5 | 8.4 | 3.0 |
| Comparative 3 | Commercial | — | 0.3 | — | — |
| Comparative 4 | Commercial | Voith t1203-8 | 27.8 | — | — |
| | Wet Laid | | | | |

TABLE 2

| | | | | | | S-CDWT | |
|---|---|---|---|---|---|---|---|
| | Transfer | | | | | (1 hour | |
| | Fabric | | Engraved | Percent | | DI | Wet |
| | P&J | Engraving | Depth | Synthetic | CDWT | water) | Caliper |
| Sample Id. | Hardness | Pattern ID | Inches | Fiber | g/3″ | g/3″ | mm |
| Control 1 | 12 | | | 0.0 | 830 | | 0.75 |
| Control 2 | 10 | 935 | 0.050 | 0.0 | 2011 | | 0.85 |
| Example 1 | 37 | 935 | 0.050 | 0.0 | 1912 | | 0.94 |
| Example 2 | 57 | 935 | 0.050 | 0.0 | 2180 | | 0.99 |
| Example 3 | 107 | 935 | 0.050 | 0.0 | 2151 | | 0.99 |
| Example 4 | 107 | 935 | 0.030 | 0.0 | 2081 | | 0.99 |
| Example 5 | 107 | 935 | 0.010 | 0.0 | 1941 | | 0.77 |
| Example 6 | 107 | SNG | 0.050 | 0.0 | 1772 | | 0.98 |
| Example 7 | 107 | 217 | 0.050 | 0.0 | 1828 | | 0.86 |
| Example 8 | 107 | 568 | 0.050 | 0.0 | 1575 | | 0.97 |
| Example 9 | 107 | 935 | 0.050 | 0.0 | 1041 | | 0.76 |
| Example 10 | 107 | 935 | 0.050 | 0.0 | 1068 | 185 | 0.68 |
| Comparative 1 | — | — | — | — | — | | — |
| Comparative 2 | — | — | — | 38.7 | 1758 | | 0.66 |
| Comparative 3 | — | — | — | — | 956 | | 0.53 |
| Comparative 4 | 12 | — | — | 0.0 | — | | — |

Comparing Examples 3, 4, and 5, it can be seen that the depth of the engraving pattern has an influence on the generated texture. In particular, it can be seen for Example 5 that when the engraved depth is about 0.010 inch, the measured Percent Shadow Area is less than 5 percent. When the engraved pattern depth was 0.030 inch and 0.050 inch, the measured Percent Shadow Areas were 23.4 percent and 27.2 percent, respectively.

Comparing the Normalized Percent Shadow Area for all samples, it can be seen that the textured air laid substrates of the present invention have superior texture over commercially available wet wipe substrates and the controls, and such texture is achieved without the addition of synthetic fibers. The air laid substrates of the present invention have texture levels that are similar to those previously achievable only with a wet laid paper machine process (Comparative 4).

Comparing Example 9 to Control 1, by using a network embossing pattern, the tensile efficiency of the binder material is increased. Example 9 has an approximately 25 percent greater CDWT (1041 v. 830 g/3″) at a similar basis weight to Control 1 (68.8 v. 64.7 gsm) even though it was made using approximately 13 percent less binder material (14.7 v. 16.9 percent binder addition). Thus, the inventive textured air laid webs not only generate superior texture, but they can be produced to the same tensile targets more cost effectively by selecting a network embossing pattern. The cost savings result from using less binder material to generate the required tensile strength.

### TEST METHODS

Percent Shadow Area

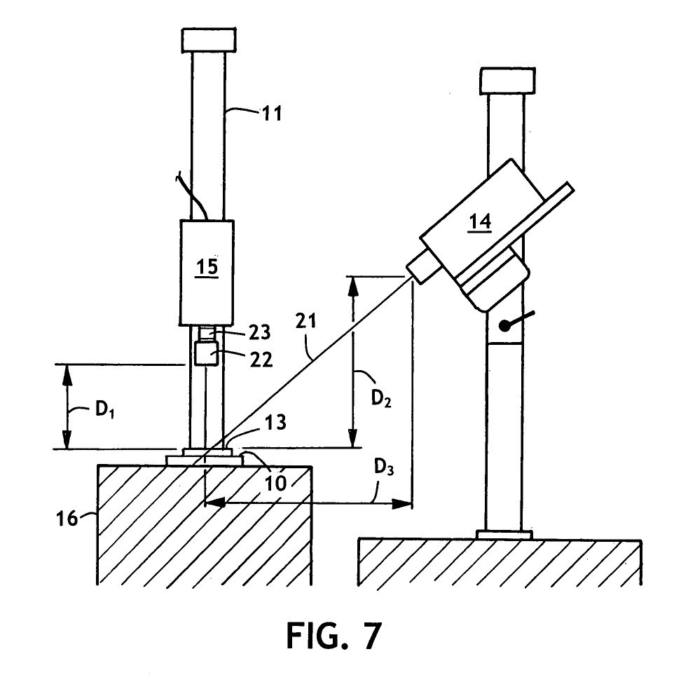

The percent shadow area determines the size of the shadow area as a percent of the surface area of an embossed substrate when illuminated by light at a predetermined angle. Referring now to FIG. 7, the apparatus and method for determining the Percent Shadow Area will be described in detail. The method involves testing an approximately 5 inch by 5 inch sample substrate 13. If the sample substrate is a wet wipe, the sample is first dried by laying the sample onto a flat glass plate to completely dry the sample without wrinkles. If desired, the sample and plate can be placed into a ventilation hood to dry. The sample is placed with the machine direction running parallel to the light source. The sample substrate is mounted onto an approximately 10 inch by 12 inch glass plate using pressure sensitive tape such as SCOTCH tape to adhere each of the sample's corners. After adhering two corners on one end of the sample, apply mild tension to the sample to remove any wrinkles and tape the other two corners onto the glass plate. The sample should be adhered such that the embossed male design of the pattern is on the sample's top surface as shown in FIGS. 3-6. The sample should lay flat with no folds or wrinkles in the area of analysis. (Folds or wrinkles will produce a shadow and generate erroneous data.) After mounting the sample, the upper surface of the sample is prepared by painting the surface, via a top-quality camel's hair brush, with a 50:50 volume mixture of n-butyl alcohol and PENTEL Correction Pen liquid or other paper liquid correction fluid. The sample should be coated with a uniform coating to increase the brightness and/or opacity of the measured surface. Care should be taken not to deform the embossing surface while applying the coating.

The substrate sample is illuminated in a darkened room with a collimated light source 21 produced by a slide projector 14, see FIG. 7. The collimated light source should hit the top plane of the sample at a 30 degree angle so that the shadow cast by the embossing is generated from the cross direction of the sample. The resulting image of the sample, with shadows from embossing superimposed, is detected by a video camera 15 having a 35-millimeter adjustable lens 22. The detected image is then processed by an image analysis system to yield a Percent Shadow Area which is the area percentage of the shadow generated by the embossing on the sample.

The camera 15 used is a SONY video camera (Model DXC-930P) synchronization and timing option (commonly called PAL format). An adjustable 35-millimeter Nikon lens 22 (Nikon Instruments, Melville, N.Y.) is mounted on the camera via a 1:1 Relay adaptor #C20047 (Century Optics, USA) 23 and had an f-stop setting of 4. The camera is mounted on a Polaroid MP-4 Land Camera (Polaroid Resource Center, Cambridge, Miss.) standard fixed column 11. The column is attached to a Kreonite macro-viewer 16 (Kreonite, Inc., Wichita, Kans.). On the surface of the macro-viewer, an auto-stage 10 produced by Design Components Incorporated, Model HM-1212, (DCI, Franklin, Miss.) is placed and used to move the sample for several measurements of the 5 inch by 5 inch piece.

The working distance D₁ between the sample substrate 13 and the bottom of the camera lens is adjusted to be approximately 33 centimeters. The sample is illuminated by a Kodak Ektographic slide projector 14 (Model AF-3). The slide projector is mounted by appropriate means such that the face of the projection lens is 37 centimeters horizontally from the video camera lens as shown by D3. The vertical distance between the slide projector lens and the sample substrate is 30 centimeters as shown by D2. These dimensions combined with the video camera set-up result in a field-of-size of the sample substrate's surface of approximately 70 millimeters by 55 millimeters. The slide projector 14 is connected to a Powerstatg Variable Autotransformer type 3PN117C (Superior Electric, Co., Bristol, Conn.). The autotransformer is used to adjust the projector illumination level.

The image analysis system used to generate the data presented is a Quantimet 600 Image Analysis System (Leica Microsystems, Wetzlar, Germany). The system is controlled and run by QWIN Version 1.06A software. The image analysis program ‘SHADIX1’ is used to acquire, process and measure images using Quantimet User Interactive Programming System (QUIPS) language. Alternatively, the SHADIX1 program could be used with a Quantimet 550 IW Image Analysis System which runs QWIN Version 2.4 software. The image analysis program is shown below.

NAME: SHADIDX1

```
PURPOSE: Measures the shadow index (i.e., area) of a textured material
AUTHOR: D. G. Biggs (adapted from optical surface crepe and method in patent #5,300,347)
DATE: February 24, 2004
CONDITIONS: SONY 930-DXP w/ 35 mm adj. Nikon lens (f/4); Projected, collimated light @
30 deg. angle; PENTEL coating on samples; mounted on ¼″ glass plate; Front of fixture
is 37 cm from front of camera; fixture base is raised to 4th hole from bottom; macroviewer
pole position = 80.0 cm
INITIALIZE VARIABLES
LFRAMECNT = 0
CALVALUE = 0.0942
FEATCOUNT = 0
TFEATCOUNT = 0
SET-UP AND CALIBRATION
Clear Accepts
Enter Results Header
Image Setup [PAUSE] ( Camera 5, White 99.17, Black 88.23, Lamp 44.64 )
Image frame ( x 0, y 0, Width 736, Height 574 )
Measure frame ( x 52, y 62, Width 636, Height 511 )
Calibrate ( CALVALUE CALUNITS$ per pixel )
For ( SAMPLE = 1 to 1, step 1 )
  PauseText ( “Set up sample plate for analysis.” )
  Image Setup [PAUSE] ( Camera 5, White 99.17, Black 88.23, Lamp 44.64 )
  STAGE SCAN PARAMETERS
  Stage (Define Origin)
  Stage (Scan Pattern, 2 × 2 fields, size 87700.234375 × 72000.195313)
  IMAGE ACQUISITION AND DETECTION
  For (FIELD = 1 to 4, step 1)
```

```
  ROUTINE TO STABILIZE LIGHT LEVEL
Y = 0
Z = 0
SP = 0
SIB = 0
P = 0
MGREYIMAGE = 0
FIELDS = 1000
TWICE = 0
Correlation GL Value for top 1% px Method, and SONY DXC930 = 187
For (LIGHT = 1 to 100, step 1)
  Image Setup (Camera 5, White 99.17, Black 88.23, Lamp 44.64)
  Live Image (into Image0)
  Measure Grey (plane MGREYIMAGE, histogram into GREYHIST(256), stats into
```

GREYSTATS(3))

Selected parameters: Pixels, MeanGrey, Std Dev

```
  A = GREYSTATS(2)
  B = GREYSTATS(3)
  D = A+B
  For (X = 129 to 256, step 1)
    Y = Y+(X*GREYHIST(X))
    Z = Z+GREYHIST(X)
  Next (X)
  R = Y/Z
  TP = GREYSTATS(1)
  ONEPCTPX = .02 * TP
  For (X = 256 to 1, step −1)
```

```
If (ONEPCTPX > SP)
  P = GREYHIST(X)
  SP = SP + P
  SIB = SIB + (X * P)
  If (ONEPCTPX < SP)
    X = 1
  Endif
Endif
```

```
  Next (X)
  AVEGL = SIB / SP
  E = AVEGL
  Display (E, field width: 8, left justified, 1 digit after ‘.’, no tab follows)
  If (E<188)
  If (E>186)
    TWICE = TWICE+1
    If (TWICE=2)
    Goto CONTINUE1
    Endif
  Endif
  Endif
  Y = 0
  Z = 0
  SP = 0
  SIB = 0
```

Next (LIGHT)
END LIGHT STABILIZER ROUTINE
CONTINUE1:
IMAGE ACQUIRE AND DETECT
Image Setup (Camera 5, White 99.17, Black 88.23, Lamp 44.64)
Acquire (into Image0)
ACQFILE$ = “C:\images\burch\3\“+STR$(FIELD)+”.TIF”
Write image (from ACQOUTPUT into file ACQFILE$, type TIF)
Detect (blacker than 95, from Image0 into Binary0 delineated)
IMAGE PROCESSING (Peak Height)
Binary Amend (Open from Binary0 to Binary1, cycles 3, operator Disc, edge erode on)
Binary Amend (Close from Binary1 to Binary2, cycles 2, operator Disc, edge erode on)
Binary Amend (Open from Binary2 to Binary3, cycles 1, operator Disc, edge erode on)
PERFORM FIRST MEASURMENTS (% Shadow Area)
Measure field (plane Binary3)

Selected parameters: Area, Perimeter, Area%

Display Field Results (x −1, y 636, w 481, h 353)
Field Histogram #1 (Y Param Number, X Param Area%, from 0. to 50., linear, 25 bins)
Display Field Histogram Results (#1, horizontal, differential, bins + graph (Y axis linear),

statistics)

Data Window (735, 478, 540, 536)

SECOND MEASUREMENT (Individual Shadow area)
Measure feature (plane Binary3, 8 ferets, minimum area: 20, grey image: Image0)

Selected parameters: Area, X FCP, Y FCP, MeanGrey

Feature Histogram #1 (Y Param Number, X Param Area, from 0.200000003 to 200.,

logarithmic, 20 bins)

Display Feature Histogram Results (#1, horizontal, differential, bins + graph (Y axis

linear), statistics)

Data Window (747, 87, 534, 448)

Binary Edit (Clear Binary3)
Stage (Step, Wait until stopped + 10 × 55 msecs)

Next (FIELD)
Print Results Header
Print (“SHADOW INDEX (% Shadow Area) ---------------------------------------------------”,

tab follows)

Print Line
Print Field Histogram Results (#1, horizontal, differential, bins + graph (Y axis linear),

statistics)

Set Image Position (left 99 mm, top 130 mm, right 179 mm, bottom 193 mm, Aspect =

Image Window,

Caption:Bottom Centre,“Example Image”)

Print Display (Image0 (on), frames (on,on), planes (off,off,off,off,off,off), lut 0, x 0, y 0, z

1, Reduction off)

Print Page
Print (“INDIVIDUAL SHADOW AREA (sq. mm) ---------------------------------------------”,

tab follows)

Print Line
Print Feature Histogram Results (#1, horizontal, differential, bins + graph (Y axis linear),

statistics)

Print Page

Next (SAMPLE)
End

Prior to testing the first sample, shading correction is performed using the QWIN software and a white, 803 Polaroid film positive (or equivalent white material) covered with an opaque, translucent film such as the color forming film layer from FUJI's Super Low pressure sensitive film. FUJI Super Low pressure sensitive film comprises a first and a second film layer that are brought together and that respond to surface pressure to leave color marks on one layer. It is often used to measure embossing pattern definition or intensity. Alternatively, other non-glossy white films or sheets can be used. The shading correction is performed using the ‘live’ mode. The system is also accurately calibrated using the QWIN software and a standard ruler with metric markings. The calibration is performed in the horizontal dimension of the video camera image.

After calibrating the system, the QUIPS routine SHADIX1 is executed via the QWIN software and will initially prompt the analyst to place the sample within the video camera's field-of-view. After positioning the sample so the machine-direction is parallel to the light source and the sample is properly aligned for auto-stage motion, the analyst will then be prompted to adjust the light level setting (via the Powerstat variable auto transformer) to register between gray-level readings of 186-188. During this process of light adjustment, the QUIPS routine SHADIX1 will automatically display the current gray-level value on the Quantimet 600 video screen.

After the light has been properly adjusted, the QUIPS routine SHADIX1 will then automatically acquire, detect, process and measure the image and the resulting shadows. The gray-level threshold value used in the routine to detect shadows is 95. The gray-level scale used on the Quantimet 600 system or equivalent is 8-bit and ranges from 0-255 (0 represents ‘black’ and 255 represents ‘white’). All regions in the image of the sample substrate that are at a gray-level of 95 or less will be detected and measured by the SHADIX1 routine.

The QUIPS routine SHADIX1 will then measure the overall percent area of the shadows in the image as well as the size of each individual shadow. Both sets of data will be placed into corresponding histograms. The QUIPS routine SHADIX1 will then automatically move the auto-stage to position the sample for the next field-of-view to be measured. The analyst will again be prompted to re-adjust the light level, if needed, and the routine will again acquire, process, and measure the image. This process will be repeated until each of the four fields-of-view is measured. The histogram data and basic statistics will then be available in both electronic and hardcopy outputs.

FIGS. 3-6 illustrate examples of the substrate's surface as seen by the camera when illuminated by the angled light that are used to determine the Percent Shadow Area. The whole image analysis and data collection process is repeated at least 3-4 times for each sample material (i.e., 3-4 replicate analyses). The mean Percent Shadow Area is then determined from the 3-4 individual results obtained and these data can then be processed using Student's T analysis statistical methods to determine if significant differences exist between sample codes.

Percent Bond Area

The Percent Bond Area is defined as the area of the raised embossing pattern on the embossing roll expressed as a percentage of the total area of the roll's surface. Preferably, the Percent Bond Area is calculated directly from the engraving drawing. If the drawing is not available, the surface of the actual engraving roll can be used to measure the respective areas. Alternatively, nip impression paper can be marked by the embossing pattern under the process conditions used and the marks on the nip impression paper measured. The size of the representative area used to calculate the Percent Bond Area should be sufficiently large to encompass at least one entire repeat of the embossing pattern. For example, a computer aided drafting program can be used to calculate the area of the top surfaces of the male embossing elements and the entire area of the roll from an engineering drawing. The Percent Bond Area can be determined by taking the ratio of the area of the top flat surface of the embossing elements divided by the entire area and then multiplying by 100. Alternatively, when the engraving drawing or engraving roll is not accessible because a competitive product is being analyzed, the surface of the textured substrate can be measured by optical means known to those of skill in the art to accurately measure the embossed male area of the substrate as a percent of the total area. Similar equipment and procedures as used to measure the Percent Shadow Area can be used. The collimated light source used to measure the Percent Shadow Area can be placed normal to the substrate's surface in order to measure the Percent Bond Area. Alternatively, an omni-direction light source can be used and placed at a low-angle (approximately less than 5 degrees) relative to the substrate's surface for this measurement. For example, a fluorescent ring light can be placed around the sample approximately 0.5 inch above the substrate's surface and used as an illumination source.

Normalized Percent Shadow Area

Without wishing to be bound by theory, the Percent Shadow Area is believed to be influenced by at least two factors. The first factor is the Percent Bond Area. As more of the surface is embossed, more shadows will be generated. The second factor is the depth of the resulting embossing in the textured substrate. As the embossing depth increases, more shadow areas will be formed. Visualize walking down a city street with lots of skyscrapers late in the afternoon as the sun is setting versus walking down a city street with only single story buildings at the same time of day. The first factor is a function of the embossing pattern chosen, while the second factor is to some degree a measure of the efficiency or success of generating deeper embossed patterns in the textured substrate.

In order to more easily compare the results of the Percent Shadow Area test between different embossing patterns, the Normalized Percent Shadow Area is determined. The Normalized Percent Shadow Area is simply the Percent Shadow Area (as a percent) divided by the Percent Bond Area (as a percent) multiplied by a constant of 10 (percent). The equation attempts to account for the Percent Bond Area influence by scaling the measured Percent Shadow Area for all samples to a hypothetical Percent Bond Area of 10 percent. Thus, samples having a measured Percent Bond Area lower than 10 percent will have a higher Normalized Percent Shadow Area than the actual measured Percent Shadow Area. Similarly, samples having a measured Percent Bond Area greater than 10 percent will have a lower Normalized Percent Shadow Area than the actual measured Percent Shadow Area. For example, Control 2 has a Normalized Percent Shadow Area of 6.5/9.6*10.0=6.7.

Strength Testing

Unless otherwise specified, tensile testing is performed according to the following protocol. Testing of substrate should be conducted under Tappi conditions (50% relative humidity, 73° F.) with a procedure similar to ASTM-1117-80, section 7. Testing is conducted on a tensile testing machine maintaining a constant rate of elongation, and the width of each specimen tested was 3 inches. The “jaw span” or the distance between the jaws, sometimes referred to as gauge length, may range from about 2.0 inches (50.8 mm) to about 4.0 inches (100.6 mm). Typically, the 2-inch gauge length is used to measure the cross direction tensile for pre-cut materials such as rolls of bathroom tissue and the 4-inch gauge length is used to measure the machine direction tensile. The crosshead speed is 12 inches per minute (254 mm/min.). A load cell or full-scale load is chosen so that all peak load results fall between 10 and 90 percent of the full-scale load. Such testing may be done on an Instron 1122 tensile frame connected to a Sintech data acquisition and control system utilizing IMAP software or equivalent system. This data system records at least 20 load and elongation points per second. Peak load (for tensile strength) and elongation at peak load (for stretch) are measured. At least ten samples for each test condition are tested and the average peak load or average stretch value is reported.

For cross direction (CD) tensile tests, the sample is cut in the cross machine direction. For machine direction (MD) tensile tests, the sample is cut in the machine direction. Cross direction wet tensile tests (CDWT) or machine direction wet tensile strength (MDWT) are performed as described above using the pre-moistened sample as is after the sample has equilibrated for temperature by sitting overnight in a sealed plastic bag.

For tests related to strength loss in a premoistened web occurring after exposure to a new solution, a container having dimensions of 200 mm by 120 mm and deep enough to hold 1000 ml is filled with 700 ml of the selected soak solution. No more than 108 square inches of sample are soaked in the 700 ml of soaking solution, depending on specimen size. The premoistened specimens, that have equilibrated overnight, are immersed in the soak solution and then allowed to soak undisturbed for a specified time period (typically 1 hour). At the completion of the soak period, samples are carefully retrieved from the soak solution, allowed to drain, and then tested immediately as described above (i.e., the sample is immediately mounted in the tensile tester and tested). In cases with highly dispersible materials, the samples often cannot be retrieved from the soaking solution without falling apart. The soaked tensile values for such samples are recorded as zero for the corresponding solution. The average of all tests conducted, both zero and non-zero, are reported.

For the deionized soaked cross-direction wet tensile test, S-CDWT, the sample is immersed in deionized water for 1 hour and then tested. For the hard-water soaked cross-direction wet tensile test, S-CDWT-M (M indicating divalent metal ions), the sample is immersed in water containing 200 ppm of Ca⁺⁺/Mg⁺⁺ in a 2:1 ratio (133 ppm Ca++/67 ppm Mg++) prepared from calcium chloride and magnesium chloride, soaked for one hour and then tested. For the medium hard water soaked cross-direction wet tensile test, MS-CDWT-M, the sample is immersed in water containing 50 ppm of Ca⁺⁺/Mg⁺⁺ in a 2:1 ratio, soaked for one hour and then tested.

Dispersibility Testing

Prior efforts to measure dispersibility of webs, whether dry or premoistened, have commonly relied on systems in which the web was exposed to shear while in water, such as measuring the time for a web to break up while being agitated by a mechanical mixer. The constant exposure to shear offers an unrealistic and overly optimistic test for products designed to be flushed in a toilet, where the level of shear is weak and extremely brief. Once the product has passed through the neck of the toilet and entered a sewage system, shear rates may be negligible. Further, the product may not be fully wetted with water from the toilet bowl when it is flushed, or rather, there may not have been adequate time for the wetting composition of the product to have been replaced with the water of the toilet bowl when the momentary shear of flushing is applied. Thus, previous measurements of dispersibility could suggest that a product is dispersible when, in fact, it may be poorly suited for a septic system.

For a realistic appraisal of dispersibility, it is believed that a relatively static measure is needed to better simulate the low shear that real products will experience once they have become fully wetted with water from the toilet. Thus, a test method for dispersibility has been developed which does not rely on shear and which provides an improved means of assessing suitability of a product for a septic system. In this method, the tensile strength of a product is measured in its original, premoistened wet form (the CDWT measurement described above) and after the product has been soaked in a second solution for one hour (either the S-CDWT or S-CDWT-M test). The second solution can be either deionized water for determination of the “Deionized Dispersibility” value or hard water (according to the S-CDWT-M test) for determination of the “Hard Water Dispersibility” value. In either case, the Dispersibility is defined as (1 minus the ratio of the cross-direction wet tensile strength in the second solution divided by the original cross-direction wet tensile strength)*100%. Thus, if a pre-moistened wipe loses 75 percent of its CD wet tensile strength after soaking in hard water for one hour, the Hard Water Dispersibility is (1-0.25)*100%=75%.

The textured substrates of the present invention can have a Deionized Dispersibility of 80 percent or greater, more specifically 90 percent or greater, specifically still 95 percent or greater, and can have a Deionized Dispersibility of about 100 percent. The articles of the present invention can have a Hard Water Dispersibility of 70 percent or greater, more specifically 80 percent or greater, specifically still about 90 percent or greater, and can have a Hard Water Dispersibility of about 100 percent.

Or, as set forth previously, the articles of the present invention would desirably have a soaked CDWT (S-CDWT) in deionized water after 1 hour of less than about 60 percent of the original in-use CDWT for the article. More desirably, the articles of the present invention have a S-CDWT in deionized water after 1 hour of less than about 50 percent of the original in-use CDWT for the article and more desirably less than about 40 percent. Even more desirably, the articles of the present invention have a S-CDWT in deionized water after 1 hour of less than about 30 percent of the original in-use CDWT for the article and more desirably less than about 20 percent. Most desirably, the articles of the present invention have a S-CDWT in deionized water after 1 hour of less than about 10 percent of the original in-use CDWT for the article.

Other modifications and variations to the present invention may be practiced by those of ordinary skill in the art, without departing from the spirit and scope of the present invention, which is more particularly set forth in the appended claims. It is understood that aspects of the various embodiments may be interchanged in whole or part. All cited references, patents, or patent applications in the above application for letters patent are herein incorporated by reference in a consistent manner. In the event of inconsistencies or contradictions between the incorporated references and this application, the information present in this application shall prevail. The preceding description, given by way of example in order to enable one of ordinary skill in the art to practice the claimed invention, is not to be construed as limiting the scope of the invention, which is defined by the claims and all equivalents thereto.

We claim:

1. An air laid substrate comprising:
cellulosic fibers formed into a web by at least one air laid former;
the substrate having two opposing surfaces and wherein at least one of the opposing surfaces comprises a textured surface; and
the at least one textured surface has a Percent Shadow Area greater than about 10 percent.

2. The air laid substrate of claim 1 wherein the Percent Shadow Area is between about 10 percent to about 40 percent.

3. The air laid substrate of claim 1 comprising an embossing pattern on the at least one textured surface.

4. The air laid substrate of claim 3 wherein the embossing pattern comprises a network pattern.

5. The air laid substrate of claim 3 or 4 wherein the embossing pattern comprises a Percent Bond Area between about 4 percent to about 50 percent.

6. The air laid substrate of claim 3 or 4 wherein the embossing pattern comprises a Percent Bond Area between about 4 percent to about 15 percent.

7. The air laid substrate of claim 1 or 4 comprising a synthetic fiber percentage of the air laid web and the synthetic fiber percentage is between about 0 percent to about 15 percent.

8. The air laid substrate of claim 1 or 4 comprising a synthetic fiber percentage of the air laid web and the synthetic fiber percentage is between about 0 percent to about 2 percent.

9. The air laid substrate of claim 5 comprising a Normalized Percent Shadow Area and the Normalized Percent Shadow area is greater than about 10 percent.

10. The air laid substrate of claim 5 comprising a Normalized Percent Shadow Area and the Normalized Percent Shadow area is between about 10 percent to about 50 percent.

11. The air laid substrate of claim 5 comprising a Normalized Percent Shadow Area and the Normalized Percent Shadow area is between about 15 percent to about 40 percent.

12. The air laid substrate of claims 1, 5, 7, or 9 comprising a binder material and wherein the binder material is a dispersible binder material.

13. The air laid substrate of claim 12 comprising an S-CDWT in deionized water and wherein the S-CDWT is less than about 50 percent of an original in-use CDWT.

14. The air laid substrate of claim 12 comprising an S-CDWT in deionized water and wherein the S-CDWT is less than about 20 percent of an original in-use CDWT.

15. The air laid substrate of claims 1, 5, 7, or 9 wherein the air laid substrate comprises a wet wipe.

16. A method of producing an air laid substrate comprising the steps of:
air forming cellulosic fibers into an air laid web;
hydrating the air laid web;
compacting the air laid web between an engraved compaction roll and a transfer fabric backed by a backing roll to form a textured air laid web, the transfer fabric having a P&J hardness greater than about 30;
applying a binder to the textured air laid web; and
drying the textured air laid web.

17. The method of claim 16 wherein the transfer fabric has a P&J hardness between about 30 to about 150.

18. The method of claim 16 wherein the transfer fabric has a P&J hardness between about 50 to about 150.

19. The method of claim 17 further comprising the step of heating the engraved compaction roll to a temperature between about 150 degrees F. to about 500 degrees F.

20. The method of claim 17 wherein the hydrating comprises spraying water onto the air laid web and a percent moisture of the air laid web after hydration is between about 0.1 percent to about 5 percent.

21. The method of claim 17 wherein the engraved compaction roll comprises an engraving depth and the engraving depth is between about 0.020 inch to about 0.1 inch.

22. The method of claim 17 wherein the engraved compaction roll comprises a network pattern.

23. The method of claim 17 wherein the engraved compaction roll comprises a Percent Bond Area and the Percent Bond Area is between about 4 percent to about 15 percent.

24. The method of claim 17 wherein the compacting comprises loading the engraved compaction roll and the backing roll at a nip load of between about 50 pli to about 400 pli.

25. The method of claim 17 wherein the binder comprises a dispersible binder.

26. The method of claim 22 comprising adding less binder material to produce an air laid substrate at approximately the same basis weight and at approximately the same CD tensile strength as an air laid substrate produced without a network embossing pattern.
